(19) United States
(12) Patent Application Publication
(10) Pub. No.: US 2008/0249645 A1
(43) Pub. Date: Oct. 9, 2008

(54) Sound data retrieval support device, sound data playback device, and program

(75) Inventor: Kei Nagiyama, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/078,668

(22) Filed: Apr. 3, 2008

(30) Foreign Application Priority Data
Apr. 6, 2007 (JP) 2007-100795

(51) Int. Cl. G06F 17/00

(52) U.S. Cl. 700/94

(57) ABSTRACT

A sound data retrieval support device includes an operation receiving unit, a sound output unit, and a control unit. The sound data retrieval support device supports the user in retrieving a desired sound data item among a plurality of sound data items. The each of the plurality of sound data items is associated with a location and a sound field in the virtual space based on attribute information items of the sound data item. The control unit causes a search point to be moved in the virtual space based on the operation command received via the operation receiving unit. The control unit causes the sound output unit to output sound that corresponds to one of the plurality of sound data items. The search point is located in the sound field of the one of the plurality of sound data items.

### CROSS REFERENCE TO RELATED APPLICATION

This application is based on and incorporates herein by reference Japanese Patent Application No. 2007-100795 filed on Apr. 6, 2007.

### BACKGROUND OF THE INVENTION

1. Field of the Invention

The present invention relates to a sound data retrieval support device.

2. Description of Related Art

Conventionally, recording media, such as compact discs, have been mainly used to possess and play back sound data. With the wide use of large-capacity devices, such as hard disks and flash memories (hereinafter referred to generally as “hard disks”), however, the volume of data that is able to be recorded on the media has been increasing. Thus, sound data playback devices have been studied such that sound data is recorded on a hard disk and desired music is played back from the hard disk.

A hard disk is able to be used with a high access speed, and music data recorded on a hard disk is able to be played back in a desired sequence. As a result, sound data recorded on plural music CDs is able to be recorded on a hard disk, and the tunes recorded from plural music CDs is able to be sorted, for example, by title name or artist name. Since the data recorded on a hard disk is able to be accessed at high speed, the time required for data selection is able to be reduced.

However, unless the sound data recorded on a hard disk is managed efficiently in a simple way, retrieving desired sound data becomes disadvantageously difficult, because a large volume of sound data is able to be recorded on a hard disk. In computers, a hierarchical structure is often used to efficiently manage a large volume of data. It may therefore be considered to use a hierarchical structure to manage sound data recorded on a hard disk. Sound data recorded on a hard disk may be managed in a hierarchical structure having multiple classification levels, for example, as follows: the sound data is generally classified by artist name; the sound data associated with each artist name is then classified by album name at a level below the artist name classification level; and the sound data associated with each album name under each artist name is classified by song title at a level below the album name classification level. In the above structure, a desired song is able to be located for playback by searching for a target artist name, a target album name belonging to the artist name, and a target song name belong to the album name in this order.

In many cases, however, the user of a sound data playback device only vaguely remembers the sound he or she recorded on the device. Besides, when the user is going to playback sound data, he or she does not necessarily have a particular piece of sound data in mind. He or she often intuitively selects sound data for playback based on his or her feelings at the moment. Therefore, when sound data is required to be managed, a hierarchical structure, which is typically used in the computer to manage stored data, may not be a good approach for sound data management. Because the sound data differs from the computer data in that the sound data influences human emotion, a more flexible management method for managing the sound data compared with the management of the computer data is preferable. The more flexible management method may be based on natural feelings of the user.

A method proposed from the above point of view is disclosed in JP-A-2007-26462. The object of JP-A-2007-26462 is to more intuitively manage a desired tune recorded from a desired music CD in cases where sound data recorded on plural music CDs is recorded on a hard disk. In the method, plural CD jackets associated with plural pieces of sound data recorded on a recording medium are displayed arranged in a standing position with one of the plural CD jackets fully shown to facilitate searching for desired sound data. In this way, the user is able to search for a desired piece of sound data in a manner of flipping music CDs accommodated in a rack one by one (see paragraph [0013] of JP-A-2007-26462). In the above, the plural pieces of sound data means multiple sound data items.

In the above method, however, the user is required to first select a CD jacket visually, next convert the CD jacket to corresponding sound, and then determine whether to play back the corresponding music. It is, however, desirable that sound data is able to be retrieved by a method in which the user is able to directly grasp a musical image by auditory sense and intuitively determine his or her selection.

Music servers have also been considered which enable the user to directly grasp, by auditory sense, a musical image required to determine sound data to be played back. In such music servers, plural pieces of sound data are each partly and automatically scanned, and sequentially played back to enable the user to select a desired piece of sound data.

The above method in which sound data is played back by being partly and automatically scanned is able to be used in combination with the method in which CD jackets are displayed as described in JP-A-2007-26462. But, even in that case, sound data is able to be searched only in sequence determined by the sequence in which the corresponding CD jackets are arranged. This reduces flexibility in search operation.

The above problem is not limited to cases where only sound data such as music data is involved. A similar problem is able to happen also when searching plural sets of audio and video data. Namely, it can happen as long as data to be searched includes sound data.

### SUMMARY OF THE INVENTION

The present invention is made in view of the above disadvantages. Thus, it is an objective of the present invention to address at least one of the above disadvantages.

An object of the present invention that has been made in view of the above situation is to provide a data retrieval support system which enables the user to directly recognize sound by auditory sense and intuitively retrieve desired sound data in a highly flexible manner.

According to one aspect of the present invention, there is provided a sound data retrieval support device that includes an operation receiving unit, a sound output unit, and a control unit. The sound data retrieval support device supports a user in retrieving a desired sound data item among a plurality of sound data items. The operation receiving unit receives an operation command by the user. The sound output unit outputs sound. The control unit performs a control. Each of the plurality of sound data items includes a plurality of attribute information items. The each of the plurality of sound data items is associated with an arrangement location and a sound field in the virtual space. The arrangement location and the sound field are determined based on a predetermined mapping rule for the virtual space. The predetermined mapping rule is determined in association with each of the plurality of attribute information items. The control unit causes a search point to be moved in the virtual space based on the operation command received via the operation receiving unit. The control unit causes the sound output unit to output sound that corresponds to one of the plurality of sound data items. The search point is located in the sound field of the one of the plurality of sound data items.

According to another aspect of the present invention, there is also provided an article manufacture that includes a computer readable medium readable by a computer and program instructions carried by the computer readable medium for causing the computer to serve as the control unit included in the above sound data retrieval support device.

According to still another aspect of the present invention, there is also provided a sound data playback device that includes the above sound data retrieval support device. When the control unit receives a predetermined selection operation command via the operation receiving unit, the control unit selects one of the plurality of sound data items for play back based on the received selection operation command. When the control unit receives a predetermined playback operation command via the operation receiving unit, the control unit causes the sound output unit to output sound that corresponds to the selected one of the plurality of sound data items.

### BRIEF DESCRIPTION OF THE DRAWINGS

The invention, together with additional objectives, features and advantages thereof, will be best understood from the following description, the appended claims and the accompanying drawings in which:

FIG. 1 is a schematic block diagram showing a general configuration of a sound data playback device 1 having a sound data retrieval support function;

FIG. 2A schematically illustrates a virtual space configuration;

FIG. 2B shows an example of virtual space display in a display section 26;

FIGS. 3A to 3C illustrate sound field arrangements;

FIGS. 4A to 4C illustrate modes of search point movement;

FIG. 5A illustrates a mode of search point movement;

FIGS. 5B and 5C illustrate arrangements for music data location;

FIGS. 6A to 6C illustrate modes of virtual space display;

FIGS. 7A to 7C illustrate modes of virtual space display;

FIGS. 8A to 8D illustrate modes of virtual space display;

FIGS. 9A and 9B illustrate example virtual spaces based on a two-dimensional orthogonal coordinate system;

FIG. 10 illustrates an example of a three-dimensional virtual space formed by adding an X axis where required;

FIG. 11 illustrates an example three-dimensional virtual space based on a three-dimensional orthogonal coordinate system; and

FIGS. 12A and 12B illustrate other embodiments of a virtual space.

### DETAILED DESCRIPTION OF PREFERRED EMBODIMENTS

Embodiments of the present invention will be described below with reference to drawings. The invention, however, is not limited to the following embodiments, and it may be modified in various ways without departing from its technical scope.

### First Embodiment

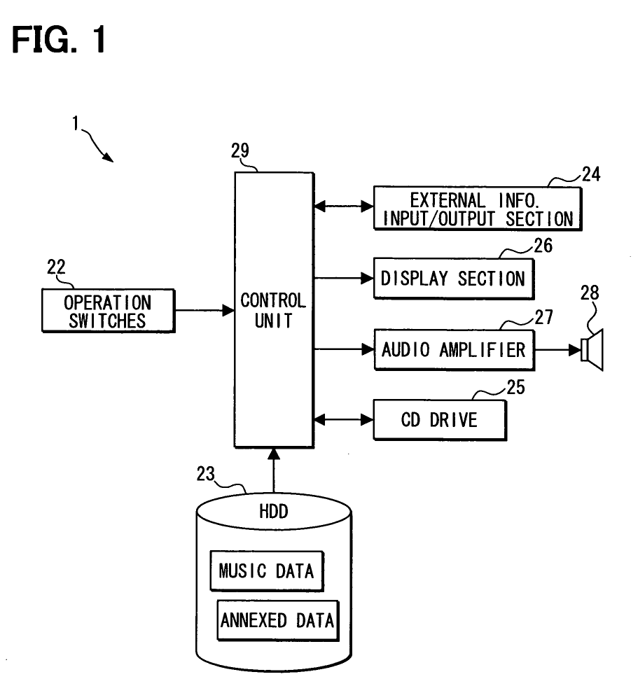

FIG. 1 is a schematic block diagram showing a general configuration of a sound data playback device 1 having a sound data retrieval support function.

The sound data playback device 1 includes an operation switches 22, a hard disk (HDD) 23, an external information input/output section 24, a CD drive 25, a display section 26, an audio amplifier 27, a speaker 28, and a control unit 29j. The operation switches 22 receives directive operation commands performed by a user, and the hard disk 23 stores various data including sound data. The external information input/output section 24 is able to receive information items from a device other than the sound data playback device 1 or output information to another device. The display section 26 displays various information. The audio amplifier 27 and the speaker 28 are configured to output various sounds. The control unit 29 executes various operations to control the external information input/output section 24, display section 26, audio amplifier 27, and CD drive 25 based on various information items and data items including directives inputted from the operation switches 22, the hard disk 23, the external information input/output section 24, and the CD drive 25.

The operation switches 22 are configured to receive various directive operation commands performed by the user. The operation switches 22 include cursor moving keys and a joystick used to accept operations for moving a search point in “a virtual space where sound data is arranged” being described in detail later.

The external information input/output section 24 is able to be connected to the Internet, for example, via a telephone line to acquire various information.

The CD drive 25 is a device for inputting various data recorded on a CD-ROM (not illustrated). An example of a CD-ROM, from which data is inputted using the CD drive 25, is a music CD, on which music data, i.e. sound data, is recorded. In this specification, the CD drive 25 is specified, for simplification, as a drive for inputting data from a storage medium. The drive to be used, however, need not necessarily be a CD drive. For example, if a DVD-ROM is used as a storage medium, a corresponding drive for the DVD may be used. There may be cases where a DVD drive is used in addition to the CD drive 25 or where a DVD/CD drive capable of reading data from a DVD drive as well as a CD-ROM may be used instead of the CD drive 25.

Music data read from a music CD via the CD drive 25 is able to be stored in the hard disk 23. Attribute information and icon image data associated with the music data is able to also be stored in the hard disk 23.

The attribute information may include, for example, category, tempo, artist name, album name, and chronological information associated with the music data.

The icon image data may be, for example, image data of an icon made from a picture of a CD jacket. Such associated information may be read from the music CD. When such associated information is not recorded on the music CD, it may be acquired from an external server via the Internet. For example, it is possible to access a predetermined server on the Internet via the external information input/output section 24 and acquire attribute information relevant to the music data based on TOC (table of contents) information read from the music CD.

The display section 26 is a color display device which may be, for example, a liquid crystal display, an organic electroluminescent display, or a cathode-ray tube display.

The audio amplifier 27 is for sound amplification. The amplified sound is outputted from the speaker 28 that is configured to be capable of outputting 3D sound, three-dimensional sound, or stereophonic sound. A 3D sound effect may be realized by using a technique in which, using only one or two speakers, a virtual sound source is generated to make the user feel as if hearing sound outputted from where no speaker is placed, or by placing three or more speakers around the user. In either case, a 3D sound effect is able to be realized under control by the control unit 29.

The control unit 29 includes a CPU, memory devices such as a ROM and a RAM, input/output ports, and a bus line connecting such constituent parts. It executes various processing operations in accordance with programs stored in memory. Processing operations executed by the control unit 29 to record or play back music on or from a music CD includes, for example: reading music data from a music CD via the CD drive 25 and recording the music data on the hard disk 23; and reading music data selected by the user using the operation switches 22 from the hard disk 23, playing back the music data, and outputting the played-back sound signal to the audio amplifier 27.

The control unit 29 accesses, via the external information input/output section 24, a predetermined server on the Internet and acquires, based on TOC information read from a music CD, relevant index data. The control unit 29 is able to then associate the index data acquired from the server with the music data read from the music CD and store the index data and the associated music data on the hard disk 23. The index data includes, for example, an artist name, an album name, and category data. The user is able to edit the index data.

### (Virtual Space, its Operation, and its Basic Advantages)

For each piece of music data read from a music CD and stored in the hard disk 23, a location in a virtual space and the configuration of a corresponding sound field in the virtual space are determined according to mapping rules which are set corresponding to plural items of relevant attribute information, respectively. In the following description, “category” and “tempo” are used as examples of such plural items of attribute information.

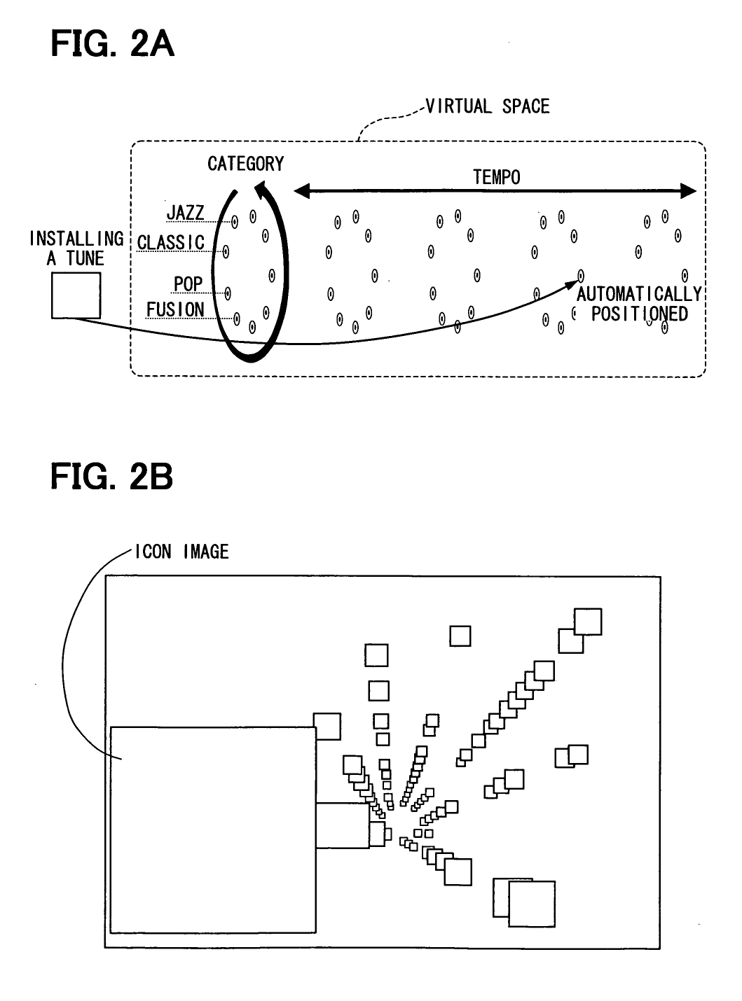

The virtual space will be described below with reference to FIGS. 2A and 2B. FIG. 2A schematically illustrates a virtual space configuration. FIG. 2B shows an example of virtual space display in the display section 26.

In the present embodiment, as shown in FIG. 2A, a linear axis is set in the virtual space and the linear axis represents “tempo” and extends in the depth direction as seen or observed from the user's viewpoint as shown in FIG. 2B. The depth direction extends further away from a side, from which the user observe the virtual space. A circular axis representing “category” is set in a plane normal to the tempo axis. The circular axis for the category extends along a circle on the plane. Music data is automatically positioned in the virtual space based on attribute information on the two attributes, i.e. category and tempo.

For each piece of music data, data on an associated icon image is set. The icon image data may be arranged or made from an image used on a CD jacket as described above. In cases where plural tunes are recorded on a music CD, the plural tunes may be associated with the same icon image data. In such cases, the icon image may be displayed, for each of the plural tunes, overlapped with the track number or the name in text of the tune, so that the user can visually distinguish between the plural tunes. The track numbers and names of the plural tunes can be set as data annexed to or associated with the relevant music data.

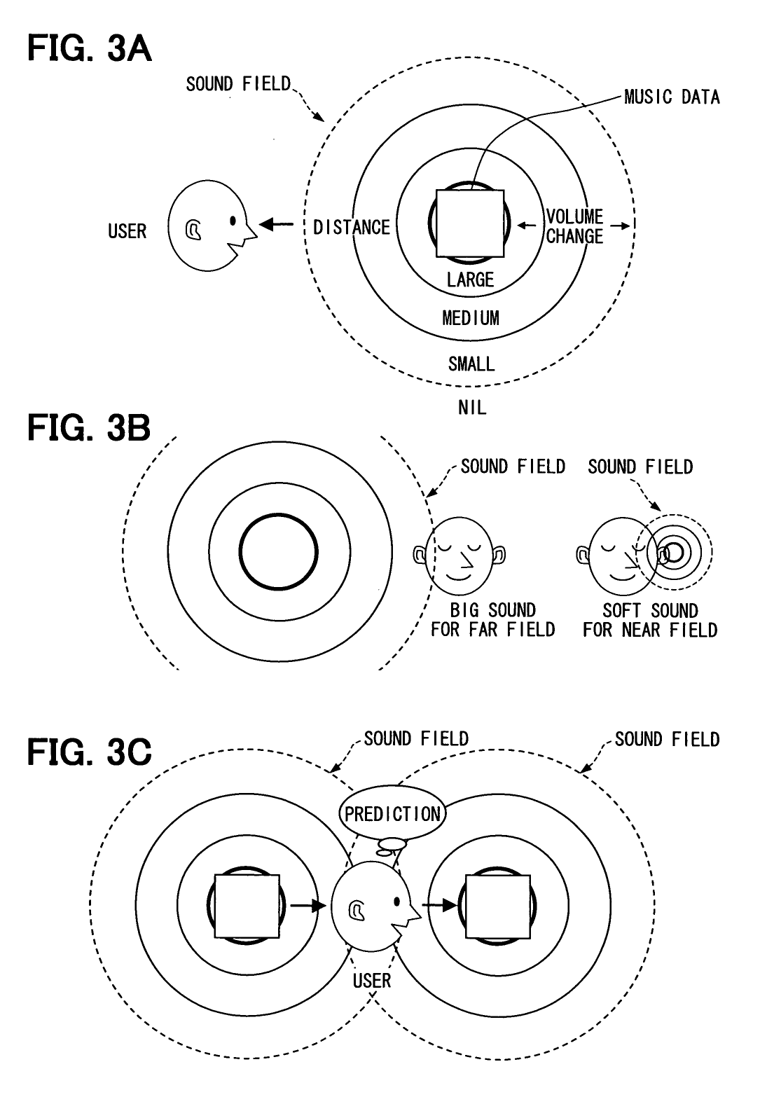

Each piece of music data or each music data item includes an associated sound field data item that is set correspondingly to the music data item. Data on a sound field is set such that, as shown in FIG. 3A, the volume of sound becomes smaller with the distance from where the music data associated with the sound field is located. In other words, when a listener is located on a position in the virtual space further away from a position of the music data, the listener is able to listen smaller volume of the sound, for example. Sound fields need not be formed uniformly for plural pieces of music data. That is, sound fields for different pieces of music data may be set differently according to attribute information associated with the different pieces of music data. For example, they may have different forms and different sizes according to the categories and tempos of the respective pieces of music.

As described above, for each piece of music data, the music data location in the virtual space, icon image data, and sound field data are set and stored in the hard disk 23. The control unit 29 is able to form the virtual space based on the music data, data on music data locations (i.e., data items on arrangement locations of music data items) in the virtual space, icon image data, and sound field data stored on the hard disk 23.

When the control unit 29 receives an operation command performed by the user using the operation switches 22 to move a search point in the virtual space, the control unit 29 moves the search point. The control unit 29 having moved the search point outputs the music sound representing the music data having a sound field provided where the search point is located via the audio amplifier 27 and the speaker 28. Typically, when the search point is moved, the sound outputted changes correspondingly. When the search point is stopped, the sound corresponding to the location where the search point is stopped is kept being outputted.

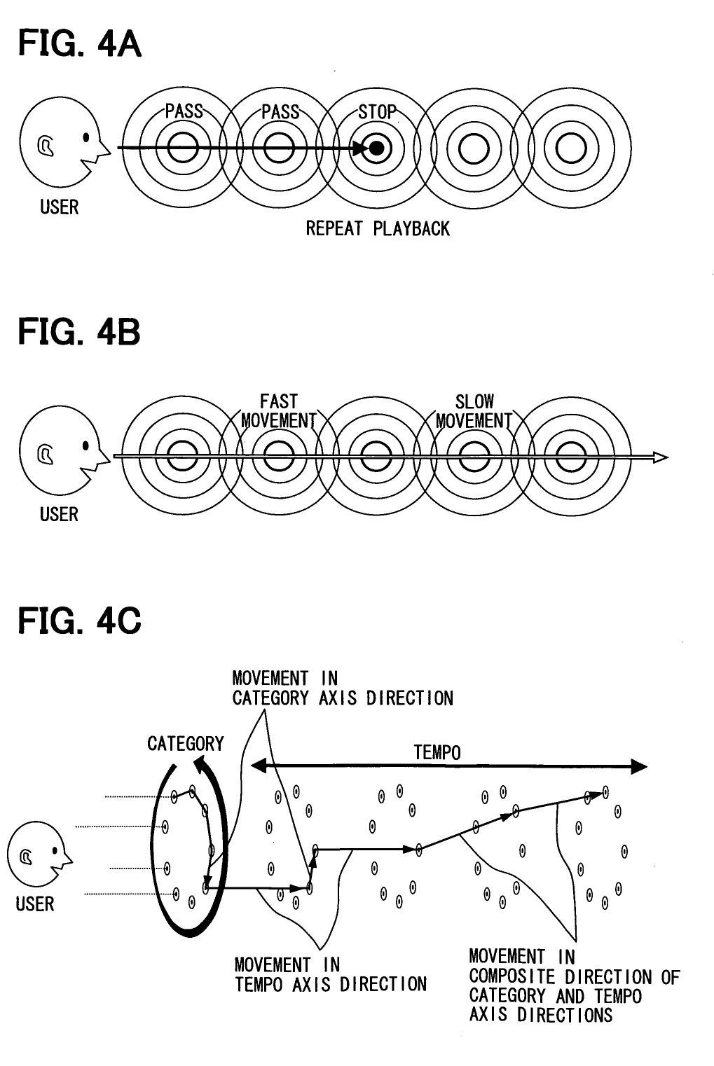

The above music sound represents a primary part (i.e., a chorus part) or an introductory part of the corresponding music. Since such a characteristic part of the corresponding music is repeatedly outputted (see FIG. 4A), the user can easily recognize the music represented by the music sound.

Furthermore, because the three-dimensional sound is outputted via the audio amplifier 27 and the speaker 28, the user is able to feel as if moving through a sound space.

Thus, the user can auditorily acquire impression of the music and intuitively retrieve desired music data. It is very desirable that the user is able to retrieve music data of his or her preference in the above described manner.

The user is able to freely move the search point in the virtual space using the operation switches 22. The user is able to instantly change the attribute information item, based on which the search is made, while searching for a desired piece of music data based on an item of attribute information. Thus, the user is able to perform a music data search with a high degree of flexibility. In cases where the virtual space is mapped based on music category and tempo as shown in FIG. 2A, the user is able to search first for a category and then for a tempo or vice versa as desired.

As described above, the user is able to enter the virtual space, freely move in the virtual space while listening to music sound, and intuitively retrieve desired music sound by auditory sense. Thus, the user is very effectively supported in searching for desired music data.

When the search point is being moved, the user is able to stop the search point partway by using the operation switches 22. When the search point is stopped, the control unit 29 outputs the music sound representing the music data provided where the search point is stopped via the audio amplifier 27 and the speaker 28. This enables the user to relaxedly search for a desired piece of music data.

Furthermore, according to the present embodiment, the virtual space is able to be displayed in the display section 26 as shown in FIG. 2B, so that the user is able to recognize the virtual space visually, too. With the icons associated with the music data located in the virtual space displayed, the user is able to visually grasp an overall music data arrangement in the virtual space. When icon images made from images for the CD jackets are displayed, the user is able to access a desired icon image referring to the corresponding image used on a familiar CD jacket. The user having accessed a desired icon image is able to then aurally recognize the corresponding music. Thus, a very useful sound data retrieval support device is able to be realized.

When the user having found a desired piece of music data by using the sound data retrieval support as described above performs a prescribed music selecting operation using the operation switches 22 and the operation is received by the control unit 29, the control unit 29 plays back the whole piece of music data selected by the user and outputs the played-back music via the audio amplifier 27 and the speaker 28.

### (Sound Field Arrangements and Advantages)

The example sound field shown in FIG. 3A is set such that the volume of sound becomes smaller with the distance from where the music data associated with the sound field is located. The user is able to therefore aurally feel the distance to or the location of the music data. This enables the user to search for desired music data feeling as if moving in the sound space.

Arrangements may be made such that sound fields for different pieces of music data is able to be formed differently according to user's operations performed using the operation switches 22. This allows the user, for example, to set the sound volume for each piece of music data flexibly as desired according to the music category or the type of tune. For music played by an orchestra, for example, a sound field may be set such that a large sound from a far away place is heard. Also, a song by a female singer may have a sound field that is set such that a small whispering voice is audible to the user from a virtual sound source close to the user (see FIG. 3B).

Furthermore, a sound field may be set to be in contact or partly overlap with another sound field in the virtual space so as to enable the user to switch his or her music selection smoothly (without unnatural feeling). Two sound fields partly overlappingly set in the virtual space as shown in FIG. 3C, for example, enable the user to predict the music data, toward which the search point is moving, while the search point is moving through the overlapping portion between the two sound fields. The sound fields partly overlappingly set in the virtual space correspond to an overlapped space section in the virtual space.

In cases where two sound fields, in each of which the volume of sound becomes smaller with the distance from where the associated music data is located (see FIG. 3A), are in contact or partly overlapped with each other, moving the search point from one of the two sound fields to the other causes the sound of the former sound field to fade out and the sound of the latter sound field to fade in.

Even though two sound fields are partly overlapped with each other in FIG. 3C, three or more sound fields may be overlapped with one another. In cases where a virtual space is arranged as shown in FIG. 2, sound fields may overlap with each other not only in the direction of the tempo axis but also in the direction of the category axis.

In cases where sound fields are overlapped, musical sounds may be outputted as follows, for example. When the search point is moved in the overlapped space section in the virtual space, the music sounds that corresponds the music data items respectively associated with the sound fields in the overlapped space section are outputted at the same time via the audio amplifier 27 and the speaker 28. In contrast, when the search point is stopped in the overlapped space section in the virtual space, the music sound that corresponds the music data item associated with a certain one of the sound fields in the overlapped space section is outputted via the audio amplifier 27 and the speaker 28. In the above case, the music sound to be outputted is determined based on the position of the search point and in accordance with a predetermined rule. For example, the predetermined rule may cause the music sound that corresponds to the music data item closest to the search point to be outputted.

In the above configuration, if a user is able to distinguish multiple music sounds that are simultaneously outputted, the user is able to move the search point gradually toward a desired piece of music data while listening to the multiple music sounds that correspond to plural pieces of music data or multiple music data items. When the user feels that the desired music data item has been reached, the user is able to stop the search point and to determine whether the music sound corresponds to the desired music data item. The above configuration advantageously facilitates a music search, in which the user aurally and intuitively searches for a desired sound while freely moving in the virtual space and listening to music sounds. To realize the above configuration or arrangement, the outputting of the three-dimensional sounds via the audio amplifier 27 and the speaker 28 is quite effective.

(Modes of Search Point Movement and their Effects)

As shown in FIG. 4B, the speed at which the search point is moved between different pieces of music data may be varied according to the operation performed by the user using the operation switches 22. For example, in a case, where a cursor key is used to move the search point, the pressing of the key longer causes the search point to move faster. In another case, where a joystick is used to move the search point, the tilting of the control lever more causes the search point to move faster. Needless to say, there are many other arrangements or configurations which is able to be made.

Causing, as described above, by changing the moving speed of the search point according to the operation command by the user, the user is able to search for the desired music data in the searching method that matches the sense of the user.

The search point is able to be made to move in various modes. For example, as in a first half portion of the trajectory of the search point movement shown in FIG. 4C, the search point may be made movable only in one of the category axis direction and the tempo axis direction by one operation. In other words, in the example case shown in FIG. 4C, the search point is first moved as desired in the category axis direction, next moved as desired in the tempo axis direction, next moved as desired in the category axis direction, then moved as desired in the tempo axis direction. Alternatively, as in a second half portion of the trajectory of the search point movement in the depth direction shown in FIG. 4C, the search point may be made movable simultaneously in both the category axis direction and the tempo axis direction by one operation. In the above way, a composite search for category and tempo is able to be made at a time, so that it becomes easier to retrieve desired music data in a direct short-cutting manner.

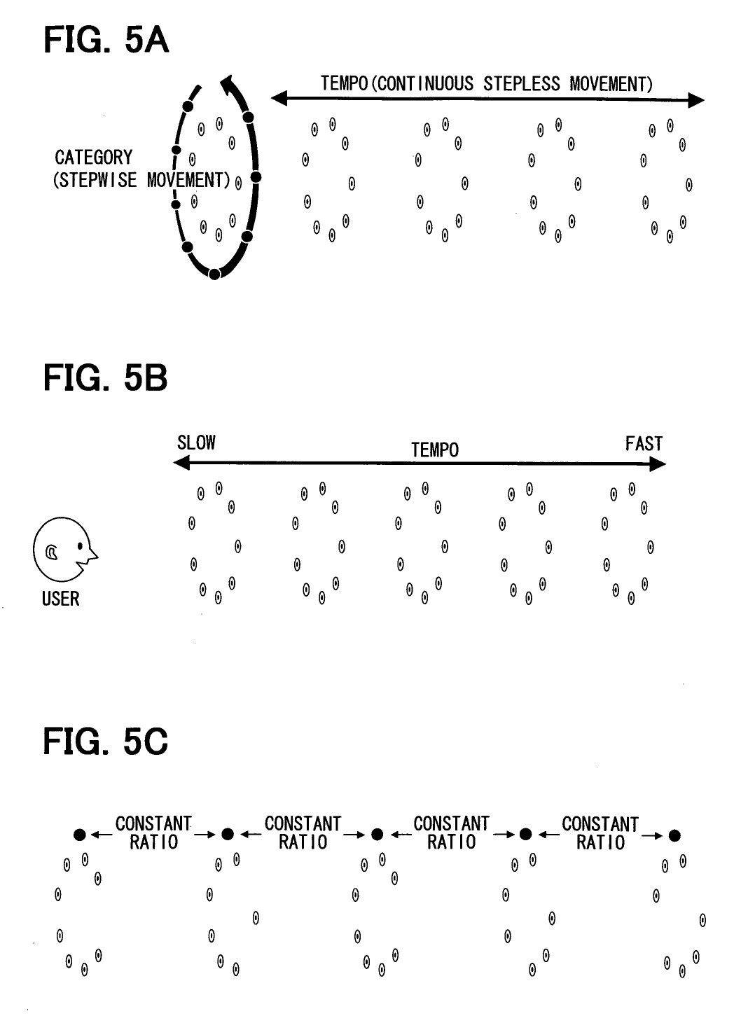

It may be made possible to switch between two operating modes for the search point. In one operation mode, the search point may be moved simply in response to the operation performed using the operation switches 22. In contrast, in the other operation mode, the search point may be moved to “capture”. For example, referring to FIG. 5A, when an operation command to move the search point in the category axis direction is made using the operation switches 22, the search point is kept automatically moved in the category axis direction to an estimated location of a music data item. The above automatic movement of the search point is named as to “capture”, and the estimated location corresponds to the arrangement location of the music data item, which arrangement location is assumed to be reached by the search point if the operation command for moving the search point is continuously received. In other words, the search point is non-linearly or stepwisely moved from one location of the music data item to another location of the music data item. In another example, when an operation command for moving the search point in the tempo axis direction is performed using the operation switches 22, the search point is linearly and steplessly moved along the tempo axis in response to the operation command. For example, the search point may be moved by an amount that corresponds to the amount of the received operation command via the operation switches 22. The above operation command of the search point in the category axis corresponds to the mapping rule determined based on the first attribute information item. Also, the operation command of the search point in the tempo axis corresponds to the mapping rule determined based on the second attribute information item.

When the movement of the search point is switched between the two operation modes, the user is able to sense the difference in the feeling of the operation. This makes it easy for the user to recognize the attribute information, based on which the user is making a search. Namely, when a relatively small operation of the operation switches 22 performed by the user causes the search point to automatically skip to a next location where music data is provided, the user is able to recognize that the user is making a search along the category axis by the above capture operation mode. Also, when the search point moves directly corresponding to the operation of the operation switches 22 performed by the user, the user is able to recognize that the user is making a search along the tempo axis.

### (Arrangements for Music Data Location)

It is conceivable that plural pieces of music data are arranged in the virtual space such that, as shown in FIG. 5B, the tempo becomes faster with the distance in the depth direction as seen from the user's viewpoint. A reverse arrangement may be also possible so that the tempo becomes slower with the distance in the depth direction as seen from the user's viewpoint. In many cases, however, when the tempo of music is adjusted by operating an operation device, the tempo is made to become gradually faster as the operation is continued. Therefore, arranging music data items such that its tempo becomes faster with the distance in the depth direction as seen from the user's viewpoint is more likely to match the sense of the user.

In the example shown in FIG. 5C, plural pieces of music data are arranged such that the tempo becomes faster at a constant ratio with the distance in the depth direction as seen from the user's viewpoint. Typically, the tempo differs between different pieces of music data, and the differences are not uniform. Thus, it may occur that the difference in tempo between two adjacent pieces of music data is small whereas the difference in tempo between the other two adjacent pieces of music data is large. Distances between plural pieces of music data arranged in a virtual space, in which the tempo linearly varies in proportion to the movement distance of the search point, are not necessarily uniform. Rather, in such a virtual space, plural pieces of music data are likely to be nonuniformly spaced. The tempo of a piece of music is sometimes indicated by the number of quarter notes or eighth notes per minute. The number is different between different pieces of music, so that, in such a virtual space, different pieces of music data are, in many cases, nonuniformly spaced in terms of tempo.

In a virtual space where different pieces of music data are nonuniformly spaced in terms of tempo, the user moving the search point from one piece of music data to another is able to feel the change in tempo based on the movement distance of the search point. When the movement distance of the search point that moves from one piece of music data to an adjacent piece of music data is relatively large, the user is able to recognize that there is no music data located between the two pieces of music data.

It is also possible for the user to grasp, by senses, his or her musical taste as represented by music data he or she owns. The user is able to realize by senses, for example, that music data relatively low or relatively high in tempo accounts for a large portion of the music data owned by him or her. Also, the user is able to realize that music data of medium-range tempos accounts for a small portion in contrast, for example. In this connection, sound fields may be alternatively configured such that, even in cases where plural pieces of music data are not uniformly distributed in terms of tempo, the sound fields are kept in contact with one another or partly overlapped with one another. As a result, the above configuration is made possible, for example, by making the sound fields correspondingly larger if the sound fields are relatively widely separated from adjacent sound fields.

In cases where plural pieces of music data are identical with each other in the category and the tempo, an arrangement may be made such that only a certain one of the multiple music data items is located at a corresponding location in the virtual space and such that the remaining music data items are located along an additional axis set based on the certain one. For example, a linear axis orthogonal to the tempo axis may be additionally defined. Alternatively, a loop axis may be additionally defined. In the virtual space arranged as described above, the search point may be made to move over the identical music data items in a predetermined sequence when a predetermined operation is performed using the operation switches 22.

### (Modes of Virtual Space Display)

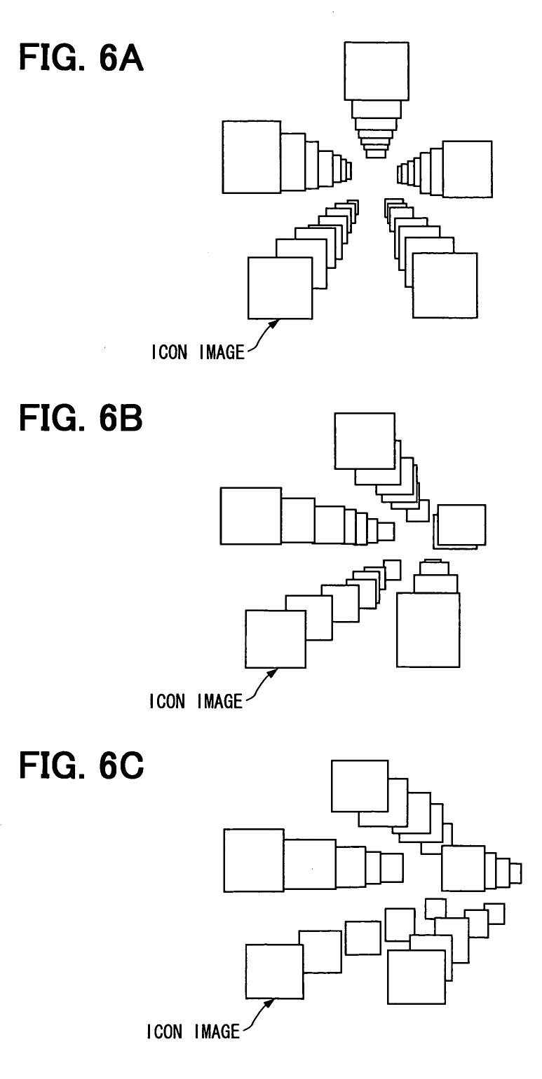

In displaying a virtual space in the display section 26, the virtual viewpoint may be determined differently, for example, as FIGS. 6A to 6C show, according to the operation command received via the operation switches 22.

Such an arrangement allows the virtual space to be viewed from different angles, making it easier to grasp the virtual space or to view a distant portion of the virtual space. For example, when an icon image to be viewed is not fully visible being partly overlapped by another icon image, the icon image can be made more visible by moving the virtual viewpoint toward one side. When icon images are displayed as shown in FIG. 6A, for example, those located in deeper portions of the virtual space cannot be seen. In such a case, changing the viewing angle by moving the virtual viewpoint toward a side makes the icon images more visible as shown in FIG. 6B. If, even after doing so, the icon images being mutually overlapped are not adequately visible, the viewing angle may be further changed by moving the virtual viewpoint more toward a side to make the icon images more visible as shown in FIG. 6C.

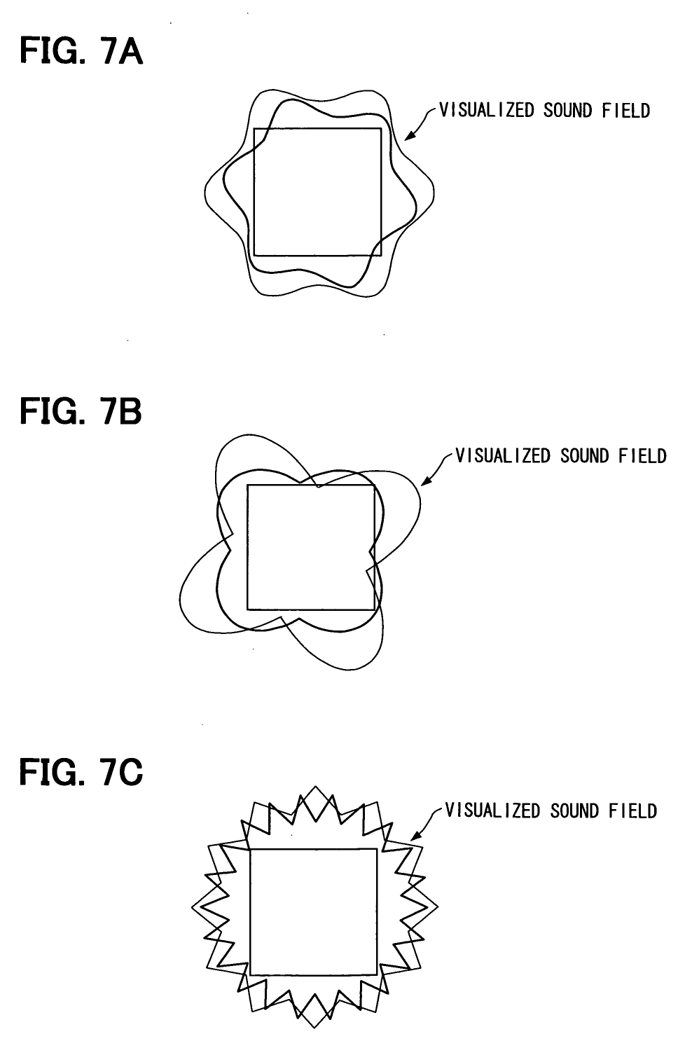

Sound fields associated with music data may be visualized, and the shapes and movements of the visualized sound fields may be differentiated between music data categories and tempos as shown in FIGS. 7A to 7C. Such an arrangement makes it easy to intuitively recognize the music data represented by a sound field having a shape visualized for the category to which the music data belongs. When visualized sound fields are moved according to the corresponding tempos, respectively, the tempos of music data not being played back may also be grasped by comparison. Such visualized sound fields can assist the user in moving the search point toward a desired piece of music data. Note that, in each of FIGS. 7A to 7C, two shapes of a visualized sound field are shown to describe the movement of the sound field.

Another virtual viewpoint is set at a deeper location along the tempo axis in a first direction and is directed in an opposite direction (second direction) opposite to the first direction. When the search point is moved in the opposite direction, another image of the virtual space viewed from the above another virtual viewpoint is correspondingly displayed and reverse icon images reversed from the original icon images are displayed. In other words, when the control unit 29 causes the search point to be moved in the virtual space in the second direction defined by the mapping rule set for the virtual space from the deeper location, the control unit 29 causes another image of the virtual space and a reversed image of the icon image to be displayed. Here, the another image of the virtual space showing the virtual space that is observed in an opposite direction from a direction of the virtual viewpoint.

The icon image may be associated with a back side image so that when the virtual space is observed from the above another virtual viewpoint in the second direction, the image of the virtual space observed in the second direction and the back side image are displayed at the arrangement location of the associated icon image. When the image of the music CD jacket is used as the icon image, the back side picture of the music CD jacket may be used as the back side image of the icon to give a different impression to the user.

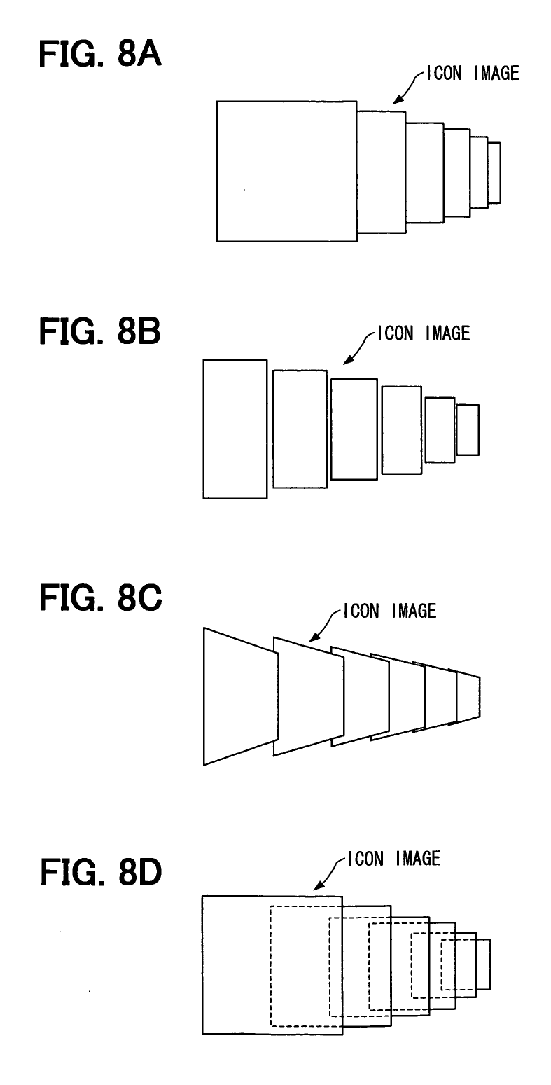

When icon images are overlappingly displayed as shown in FIG. 8A, the visibility of icon images displayed behind plural icon images can be inadequate. In such cases, the icon images may be processed or adjusted to improve their visibility by deforming the images (see FIG. 8B), adjusting the orientation of the images (see FIG. 8C), and making the images transparent (see FIG. 8D).

### (Other Arrangements)

The virtual space described in the above examples has a linear category axis extending in the depth direction as seen from the user's viewpoint and a circular category axis provided in a plane normal to the tempo axis. The mapping rules based on which the virtual space is arranged or the attribute information based on which the mapping rules are set may be made alterable by the control unit 29 according to the operation command received via the operation switches 22.

For example, the mapping rules may be changed as follows. When the music data items owned by the user are classified into only four categories, the category axis in the virtual space may have a rectangular shape instead of the circular shape. When the music data items owned by the user are classified into a large number of categories, the virtual space may alternatively have a linear axis indicative of the category and a circular axis indicative of the tempo contrary to that shown in FIG. 2A. In the above alternative virtual space, the linear axis extends in the depth direction as seen from the user's viewpoint, and the circular axis is set in a plane normal to the linear category axis.

The attribute information based on which the mapping rules are set need not necessarily be, as shown in FIG. 2A, category and tempo. The user may be enabled to change the attribute information items as desired, and the attribute information items may be associated with the category and the chronological information or with the chronological information and the artist, for example.

In the ways described above, a virtual space can be formed which enables the user to search for desired music data in a manner fitting his or her taste and feeling.

### (Correspondence to Claims)

The operation switches 22 are equivalent to the operation receiving unit. The audio amplifier 27 and speaker 28 are equivalent to the sound output unit. The control unit 29 and the display section 26 are equivalent to the control unit and the display unit, respectively.

### Second Embodiment

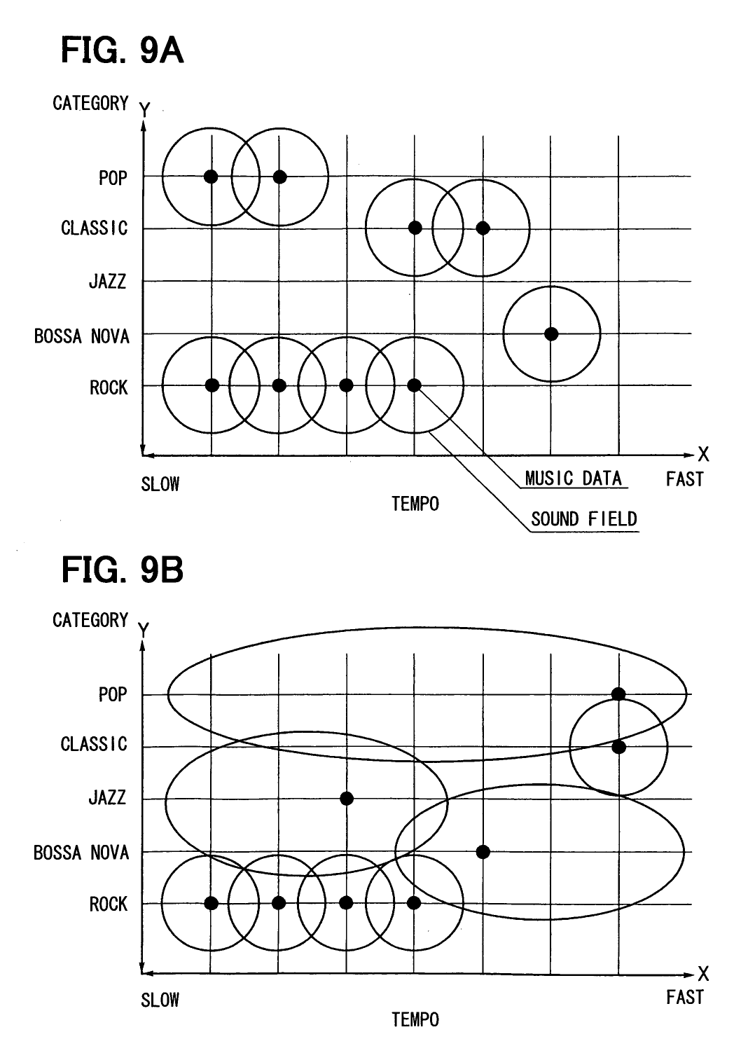

FIG. 9A shows an example of virtual space formed based on a two-dimensional orthogonal coordinate system having an X axis (horizontal axis) representing tempo and a Y axis (vertical axis) representing category. The search point used in the virtual space shown in FIG. 9A may be made capable of freely moving over the X-Y coordinates or only capable of skipping between X-Y coordinate points.

In another example of virtual space shown in FIG. 9B, if there is no music data located in a certain area in the coordinate, the certain area is covered by the nearest sound field or the nearest sound field of the same category and tempo, which sound field is enlarged. As a result, in a case, where the search point used in the virtual space is only allowed to skip between X-Y coordinate points, sound is always heard regardless of the position of the search point. In other words, referring to FIG. 9B, in a case, where the search point is only allowed to skip between intersections between lines representing tempo along the X axis and lines representing category along the Y axis, sound is always heard regardless of the position of the search point.

### Third Embodiment

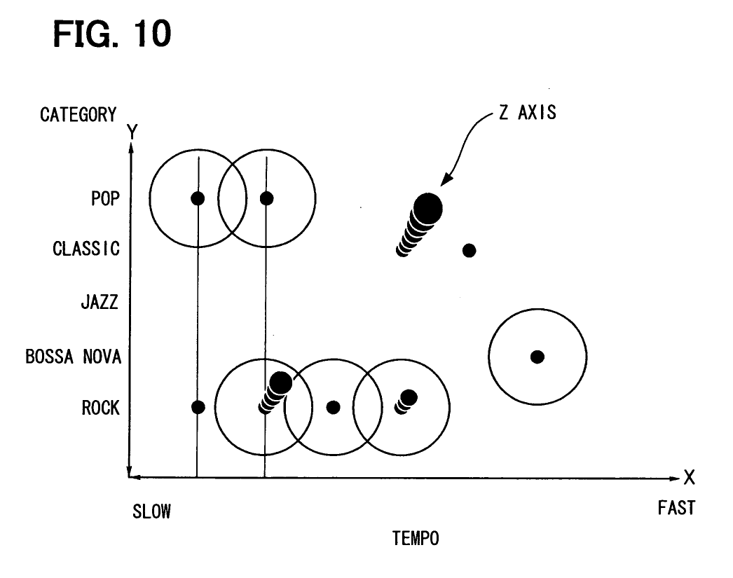

FIG. 10 shows an example of three-dimensional virtual space formed by adding a Z axis at a position in a two-dimensional virtual space based on a two-dimensional orthogonal coordinate system similar to systems shown in FIGS. 9A and 9B. In the three-dimensional virtual space, when there are plural pieces of music of a same category and a same temp, a Z axis is added perpendicularly to both the X and Y axes such that the plural pieces of music data representing the plural pieces of music are enabled to be stacked along the Z axis. The search point to be used in the three-dimensional virtual space may be arranged such that, when a predetermined operation is performed using the operation switches 22, the search point is moved to sequentially find the plural pieces of music data of the same category and tempo in a predetermined order.

### Fourth Embodiment

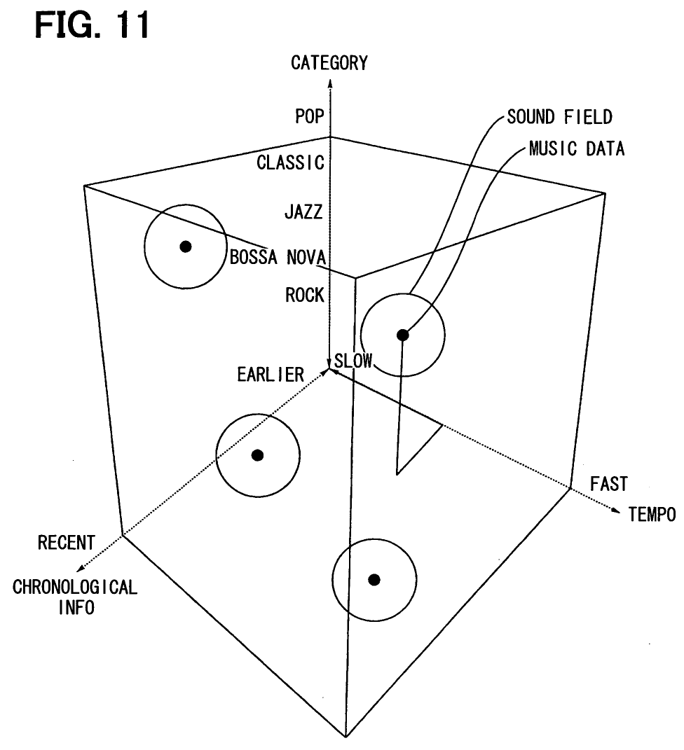

FIG. 11 shows an example of virtual space formed based on a three-dimensional orthogonal coordinate system which has X, Y, and Z axes representing three items of attribute information selected among plural items of attribute information, such as category, tempo, chronological information, and area. Here, the chronological information may include a year associated with the music data item. Music data is arranged or mapped in the virtual space based on the three items of attribute information. The three orthogonal axes of the virtual space shown in FIG. 11 represent tempo, category, and chronological information, respectively.

The search point in the virtual space may be freely moving in the X-Y-Z coordinates or only capable of skipping between X-Y-Z coordinate points similar to the case of the virtual space based on a two-dimensional coordinate system shown in FIG. 9A. In the case of the three-dimensional virtual space, too, when there are areas provided with no music data, the above areas may each be covered the enlarged nearest sound field or the enlarged nearest sound field of the same category, tempo, and chronological information in a manner similar to the case of the two-dimensional virtual space shown in FIG. 9B.

### Other Embodiments

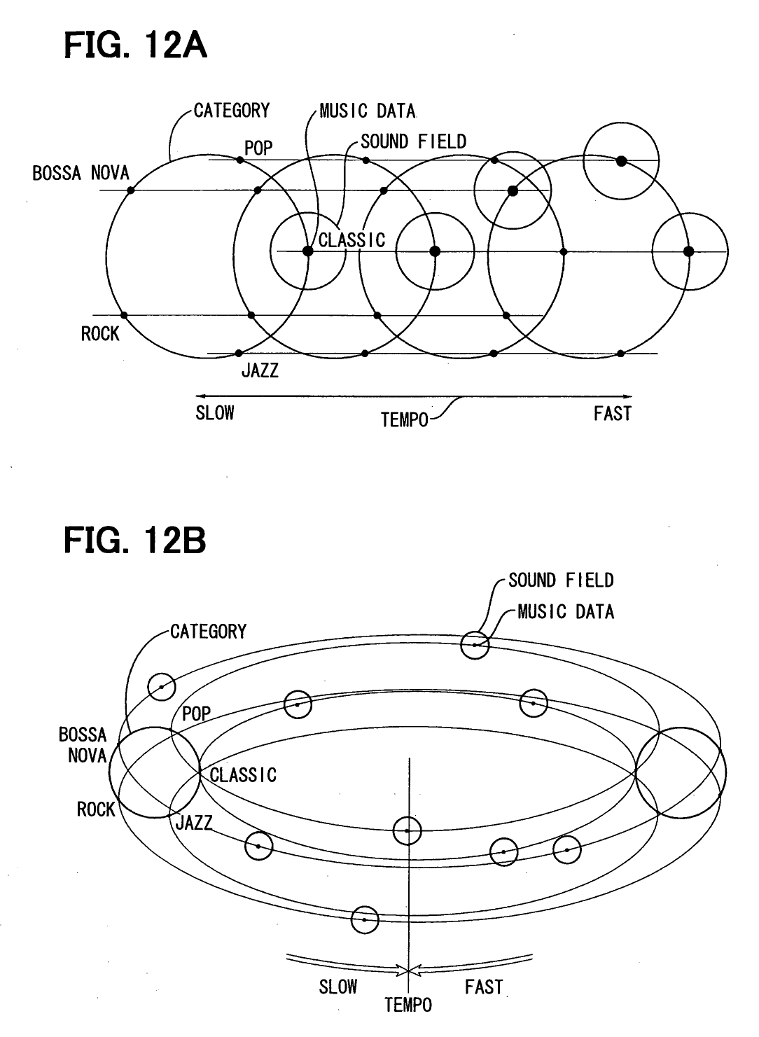

FIG. 12A shows an example of virtual space which is equivalent to a two-dimensional version of the three-dimensional virtual space of the first embodiment shown in FIG. 2A. The two-dimensional virtual space has a laterally extending tempo axis and plural circular category axes. The circular category axes are two-dimensionally arranged and are displaced from each other along the tempo axis such that the circular category axes are arranged on locations on the same plane as the temp axis. In this virtual space, when the search point that is positioned on a location of a certain music data item on the category axis is moved along the tempo axis, the search point is moved to a location of a corresponding music data item on another category axis. Here, the corresponding music data item is associated with the same category to the certain music data item and with a different tempo from the certain music data item.

FIG. 12B shows another example of three-dimensional virtual space which is equivalent to the virtual space shown in FIG. 2A for the first embodiment but with the linear tempo axis converted into a ring-shaped axis allowing music data to be arranged along the ring-shaped tempo axis.

### (Other Notes)

(1) Even though the above embodiments have been described based on example virtual spaces in which music data is arranged as sound data, the sound data need not necessarily be music data. Sound data may be voice data or may be other audio data that is classified into a category other than the voice data and the music data. The sound data may also be combined with image data. In other words, the present invention is able to be applied to any contents data containing sound data. The above contents data includes sound materials, such as video clips containing radio sound, photos accompanied by messages, TV sound materials, and sound effect materials, and movies.

(2) The above embodiments have been described as the sound data playback device 1 having a sound data retrieval support function, but the present invention can also be realized as a sound data retrieval support device having a sound data retrieval support function only.

Additional advantages and modifications will readily occur to those skilled in the art. The invention in its broader terms is therefore not limited to the specific details, representative apparatus, and illustrative examples shown and described.

What is claimed is:

1. A sound data retrieval support device for supporting a user in retrieving a desired sound data item among a plurality of sound data items, the sound data retrieval support device comprising:
an operation receiving unit that receives an operation command by the user;
a sound output unit that outputs sound; and
a control unit that performs a control, wherein:
each of the plurality of sound data items includes a plurality of attribute information items;
the each of the plurality of sound data items is associated with an arrangement location and a sound field in the virtual space, the arrangement location and the sound field being determined based on a predetermined mapping rule for the virtual space, the predetermined mapping rule being determined in association with each of the plurality of attribute information items;
the control unit causes a search point to be moved in the virtual space based on the operation command received via the operation receiving unit; and
the control unit causes the sound output unit to output sound that corresponds to one of the plurality of sound data items, the search point being located in the sound field of the one of the plurality of sound data items.

2. The sound data retrieval support device according to claim 1, wherein:
the virtual space is three-dimensional;
the plurality of attribute information items corresponds to three attribute information items;
the arrangement location and the sound field of the each of the plurality of sound data items in the three-dimensional space is determined based on the predetermined mapping rule for the three-dimensional space, the predetermined mapping rule being determined in association with each of the three attribute information items of the each of the plurality of sound data items.

3. The sound data retrieval support device according to claim 1, wherein:
the control unit causes the search point in the virtual space to be moved in a first direction and in a second direction and to be stopped based on the operation command received via the operation receiving unit, the second direction being opposite to the first direction, the first and second directions being determined based on the predetermined mapping rule.

4. The sound data retrieval support device according to claim 1, wherein:
the control unit causes the search point to be moved in the virtual space at a speed that is changed based on the operation command received via the operation receiving unit.

5. The sound data retrieval support device according to claim 1, wherein:
the control unit causes the search point to be automatically moved to an estimated location when the operation command for moving the search point is received via the operation receiving unit, the estimated location corresponding to the arrangement location of one of the plurality of sound data items, which arrangement location is assumed to be reached by the search point if the operation command for moving the search point is continuously received.

6. The sound data retrieval support device according to claim 1, wherein:
the control unit causes the search point to be automatically moved to an estimated location in response to the operation command for moving the search point received via the operation receiving unit in a case, where the search point is moved based on the mapping rule determined in association with a first one of the plurality of attribute information items, the estimated location corresponding to the arrangement location of one of the plurality of sound data items, which arrangement location is assumed to be reached by the search point if the operation command for moving the search point is continuously received; and
the control unit causes the search point to be moved based on the operation command when the operation command for moving the search point is received via the operation receiving unit in a case, where the search point is moved based on the mapping rule determined in association with a second one of the plurality of attribute information items.

7. The sound data retrieval support device according to claim 1:
wherein the sound field is set such that a sound volume becomes smaller with a distance from the arrangement location of a corresponding one of the plurality of sound data items.

8. The sound data retrieval support device according to claim 1:
wherein the sound field is configured according to the attribute information item of the each of the plurality of sound data items.

9. The sound data retrieval support device according to claim 1:
wherein the control unit changes an arrangement of the sound field for a corresponding one of the plurality of sound data items based on the operation command received via the operation receiving unit.

10. The sound data retrieval support device according to claim 1, wherein:
the sound field of a first one of the plurality of sound data items is in contact with or partly overlapped with the sound field of a second one of the plurality of sound data items in the virtual space, the sound field of the first one being located adjacent to the sound field of the second one.

11. The sound data retrieval support device according to claim 10 wherein:
when the control unit causes the search point to be moved in an overlapped space section in the virtual space, the control unit causes the sound output unit to simultaneously output the sounds that correspond to the first and second ones of the plurality of sound data items, the sound fields of the first and second ones of the plurality of sound data items being partly overlapped with one another in the overlapped space section; and
when the control unit causes the search point to be stopped in the overlapped space section in the virtual space, the control unit causes the sound output unit to output the sound that corresponds to a certain one of the plurality of sound data items, the certain one of plurality of sound data items being determined using a rule predetermined based on a location, at which the search point is stopped.

12. The sound data retrieval support device according to claim 1, wherein:
in a state, where one of the plurality of attribute information items is a numeric information item, the mapping rule that is determined in association with the numeric information item is set such that the numeric value of the numeric information item changes proportionally to a movement distance of the search point in the virtual space.

13. The sound data retrieval support device according to claim 1, the sound data retrieval support device further comprising:
an image display unit that is configured to display an image, wherein:
the each of the plurality of sound data items is associated with a corresponding icon image;
the control unit causes the image display unit to display an image of the virtual space observed from a virtual viewpoint determined based on a predetermined rule determined according to a location, at which the search point is located, the corresponding icon image being located at the arrangement location of the each of the plurality of sound data items in the virtual space.

14. The sound data retrieval support device according to claim 13:
wherein the control unit changes the predetermined rule for determining the virtual viewpoint based on the operation command received via the operation receiving unit.

15. The sound data retrieval support device according to claim 13:
wherein, in a case, where the control unit causes the search point to be moved in the virtual space in the second direction defined by the mapping rule set for the virtual space based on the operation command received via the operation receiving unit, the control unit causes the image display unit to display another image of the virtual space and a reversed image of the icon image, the another image of the virtual space showing the virtual space that is observed in an opposite direction from a direction of the virtual viewpoint.

16. The sound data retrieval support device according to claim 13, wherein:
the icon image is associated with another image for an opposite side of the icon image in the virtual space opposite to the virtual viewpoint, and in a case, where the control unit causes the search point to be moved in the virtual space in the second direction defined by the mapping rule set for the virtual space based on the operation command received via the operation receiving unit, the control unit causes the image display unit to display another image of the virtual space and the another image of the icon image, the another image of the virtual space showing the virtual space that is observed in an opposite direction from a direction of the virtual viewpoint.

17. The sound data retrieval support device according to claim 13:
wherein in a case, where the control unit causes the image display unit to display the image of the virtual space observed from the virtual viewpoint, and where the icon images are overlapped with one another such that visibility of the icon images is decreased, the icon images are adjusted such that the visibility of the icon images is increased, the icon images being adjusted by one of the following manners:
deforming at least one of the icon images;
changing an orientation of at least one of the icon images; and
making at least one of the icon images transparent.

18. The sound data retrieval support device according to claim 1:
wherein in a case, where the control unit causes the sound output unit to output the sound that corresponds to the one of the plurality of sound data items, the control unit repeatedly outputs a sound that corresponds to a predetermined characteristic part of the one of the plurality of sound data items.

19. The sound data retrieval support device according to claim 1:
wherein in a case, where an additional sound data item having a plurality of attribute information items is added to the plurality of sound data items, the control unit determines an arrangement location and a sound field in the virtual space for the additional sound data item based on the predetermined mapping rule for the virtual space using the plurality of attribute information items of the additional sound data.

20. The sound data retrieval support device according to claim 1:
wherein according to the operation command received via the operation receiving unit, the control unit changes one of (a) the predetermined mapping rule and (b) one of the plurality of attribute information items corresponding to the predetermined mapping rule.

21. An article manufacture comprising:
a computer readable medium readable by a computer; and
program instructions carried by the computer readable medium for causing the computer to serve as the control unit included in the sound data retrieval support device according to claim 1.

22. A sound data playback device comprising the sound data retrieval support device according to claim 1:
wherein, when the control unit receives a predetermined selection operation command via the operation receiving unit, the control unit selects one of the plurality of sound data items for play back based on the received selection operation command; and
wherein, when the control unit receives a predetermined playback operation command via the operation receiving unit, the control unit causes the sound output unit to output sound that corresponds to the selected one of the plurality of sound data items.
